(19) United States
(12) Patent Application Publication
(10) Pub. No.: US 2025/0054231 A1
(43) Pub. Date: Feb. 13, 2025

(54) GRAPHICALLY DEFINING CONTACT-GENERATING EVENTS IN A VIRTUALIZED METAVERSE

(71) Applicant: INTERNATIONAL BUSINESS MACHINES CORPORATION, Armonk, NY (US)

(72) Inventors: Ya Qing CHEN, Shanghai (CN); Liang Ying XU, Beijing (CN); Jian WANG, Shanghai (CN); Chuan Le ZHENG, Shanghai (CN); Xiao Feng JI, Shanghai (CN)

(73) Assignee: INTERNATIONAL BUSINESS MACHINES CORPORATION, Armonk, NY (US)

(21) Appl. No.: 18/448,850

(22) Filed: Aug. 11, 2023

(51) Int. Cl. G06T 17/00; G06F 3/04815; G06F 3/04842; G06T 11/20

(52) U.S. Cl. CPC G06T 17/00; G06F 3/04815; G06F 3/04842; G06T 11/203; G06T 2207/20104

(57) ABSTRACT

Computer-implemented peer-engagement through graphical definition of contact-generating events in a virtualized metaverse includes visually presenting to a user, on an interactive interface, a multi-dimensional scene of a virtual environment. The user provides input to graphically define one or more contact-generating events within the multi-dimensional scene, which events are detected as being triggered by one or more virtualized avatars in the multi-dimensional scene. According to the triggering of the events and other predefined contact-engaging criteria, a contact-initiating prompt may be transmitted to a peer user associated with the one or more virtualized avatars in the multi-dimensional scene.

### BACKGROUND OF THE INVENTION

Embodiments of the invention generally relate to computing systems, and more particularly, to interactive graphical definition of event areas for potential peer-engagement within a virtualized metaverse.

### SUMMARY OF THE INVENTION

According to an embodiment, a computer-implemented method for peer-engagement through graphical definition of contact-generating events in a virtualized metaverse is disclosed. The computer-implemented method includes visually presenting to a user, on an interactive interface by one or more processors, a multi-dimensional scene of a virtual environment. The computer-implemented method further receives input from the user, by the one or more processors, graphically defining one or more contact-generating events within the multi-dimensional scene. The computer-implemented method further detects, by the one or more processors, one or more virtualized avatars in the multi-dimensional scene triggering the one or more contact-generating events. The computer-implemented method further transmits a contact-initiating prompt, by the one or more processors, to a peer user associated with the one or more virtualized avatars in the multi-dimensional scene according to the detected one or more contact-generating events and predefined contact-engaging criteria.

An embodiment includes a computer usable program product. The computer usable program product includes a computer-readable storage device, and program instructions stored on the storage device executable to perform similar functionality.

An embodiment includes a computer system. The computer system includes a processor, a computer-readable memory, and a computer-readable storage device, and program instructions stored on the storage device for execution by the processor via the memory to perform similar functionality.

### BRIEF DESCRIPTION OF THE SEVERAL VIEWS OF THE DRAWINGS

FIG. 1 is a block diagram depicting a computing device in which operations of the description may be performed.

FIG. 2 is a block diagram depicting a computer network system, inclusive of the computing device, in which operations of the description may be performed.

FIGS. 3A-3C are schematic views depicting a scene in a virtualized metaverse.

FIG. 4 is a flow diagram illustrating operations for peer-engagement through graphical definition of contact-generating events in the virtualized metaverse.

FIGS. 5A-5C are schematic views depicting mapping operations to graphically define contact-generating events in the virtualized metaverse.

FIG. 6 is a schematic view depicting bounding operations to graphically define contact-generating events in the virtualized metaverse.

FIGS. 7A-7C are schematic views depicting triggering operations to graphically define contact-generating events in the virtualized metaverse.

FIG. 8 is a schematic view depicting additional triggering operations to graphically define contact-generating events in the virtualized metaverse.

FIGS. 9A-9C are schematic views depicting operations to filter graphically-defined contact-generating events in the virtualized metaverse.

FIG. 10 is a block diagram depicting operations to list potential contacts satisfying the contact-generating criteria in the virtualized metaverse.

### DETAILED DESCRIPTION OF THE INVENTION

The so-called “metaverse,” or “Metaverse” is a shared, decentralized, and digital space that exists beyond the real world. It may be experienced through virtual reality (VR) or augmented reality (AR), and includes a virtual environment where humans are represented by an avatar. In this way, users may interact with other users, both socially and economically, through their respective avatars and with software agents in a cyber space.

The metaverse is a virtualized location where humans and other objects in the real world can co-exist in digital forms, in similar fashion to how humans and other objects can exist physically in our own world. People are able to design a particular environment of the metaverse by themselves, so that this environment will be unique to each person who visits that environment. Generally, the virtual environment in a metaverse is built upon a metaphor of the real world, but in most cases, without the physical limitations of the real world. In a metaverse application, users are enabled to have friends (or contacts), create groups, and talk and mingle with strangers, fly, and teleport to different locations, and different metaverses.

A feature of the metaverse is the ability to bring together users from all over the world into the same virtual environment. These users may be located in differing countries and associate with different cultures, yet share similar interests and hobbies based on the virtual environment they attend. Therefore, it is another feature of the metaverse to provide spaces to allow these users having similar interests to engage with one another socially, by chat messaging or other means.

Accordingly, embodiments of the invention described herein provide technical solutions for improving peer-engagement in such a virtual environment, by implementing mechanisms which more efficiently connect users whom may want to remain in contact with one another. In an embodiment, these mechanisms include visually presenting to a user, on an interactive interface by one or more processors, a multi-dimensional scene of a virtual environment. Input is received from the user, by the one or more processors, graphically defining one or more contact-generating events within the multi-dimensional scene. One or more virtualized avatars in the multi-dimensional scene are detected, by the one or more processors, as triggering the one or more contact-generating events. According to the triggering of the events and other predefined contact-engaging criteria, a contact-initiating prompt may be transmitted to a peer user associated with the one or more virtualized avatars in the multi-dimensional scene.

In an embodiment, the multi-dimensional scene comprises a two-dimensional (2D) map of the virtual environment and comprising one or more virtualized objects; or a miniaturized three-dimensional (3D) model of the virtual environment and comprising one or more virtualized objects.

In an embodiment, the graphically defining of the one or more contact-generating events comprises receiving the input from the user to select an object of the one or more virtualized objects as a location boundary of the one or more contact-generating events; and the triggering of the one or more contact-generating events comprises identifying the peer user associated with the one or more virtualized avatars has viewed the object.

In an embodiment, the graphically defining of the one or more contact-generating events comprises receiving the input from the user to draw one of a plurality of symbols respectively representative of a plurality of predefined actions requisite to initiate the one or more contact-generating events; and the triggering of the one or more contact-generating events comprises identifying the peer user associated with the one or more virtualized avatars has performed one or more of the plurality of predefined actions.

In an embodiment, the one or more virtualized objects are real-world objects represented in the virtual environment; and a category of the one or more virtualized objects in the virtual environment is automatically identified by known information of the real-world objects, wherein the category consists of a portion of the predefined contact-engaging criteria.

In an embodiment, the one or more virtualized avatars detected as having triggered the one or more contact-generating events are filtered, by the one or more processors, according to the predefined contact-engaging criteria; and a list of the filtered one or more virtualized avatars is visually presented to the user on the interactive interface.

In an embodiment, responsive to accepting the contact-initiating prompt by the peer user associated with the one or more virtualized avatars, the user and the peer user are connected as contacts (i.e., friends) in the virtualized metaverse.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

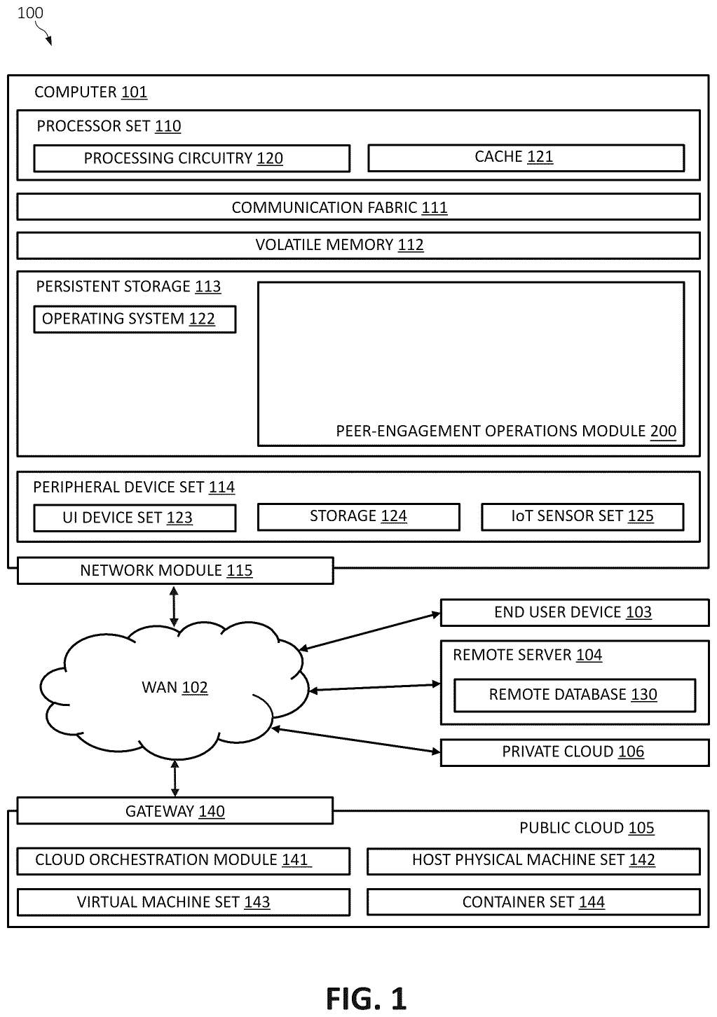

Turning now to FIG. 1, computing environment 100 contains an example of an environment for the execution of at least some of the computer code involved in performing the inventive methods, such as peer-engagement operations module 200. In addition to peer-engagement operations module 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and peer-engagement operations module 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in peer-engagement operations module 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

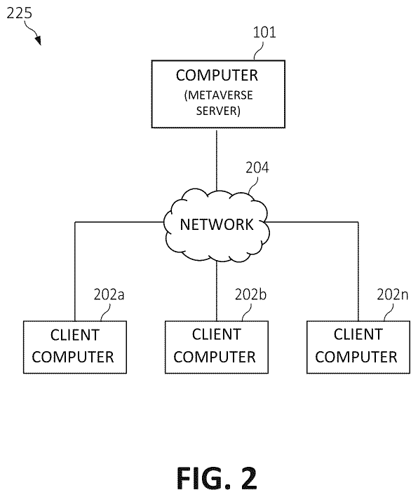

FIG. 2 depicts a schematic diagram of one embodiment of a computer network system 225. The illustrated computer network system 225 includes client computers 202a, 202b, and 202n (collectively referred to herein as client computers 202a . . . n), computer 101 (operating, for example, as a metaverse server), and network 204. The computer network system 225 may interface a system user and computer 101 according to the interface operations of the client computers 202a . . . n. Although the depicted computer network system 225 is shown and described herein with certain components and functionality, other embodiments of the computer network system 225 may be implemented with fewer or more components or with less or more functionality. For example, some embodiments of the computer network system 225 include a plurality of computers 101 and a plurality of WANs 102. Additionally, some embodiments of the computer network system 225 include similar components arranged in another manner to provide similar functionality, in one or more aspects.

The client computers 202a . . . n may incorporate all of the resources of the computer 101 and operate as VR clients to manage the interface between a system user and the computer 101. In one aspect, each of the client computers 202a . . . n are associated with one user. In another aspect, one or more of the client computers 202a . . . n is associated with multiple users. In an embodiment, one or more of the client computers 202a . . . n are desktop computers or laptop computers. In an embodiment, one or more of the client computers 202a . . . n are mobile computing devices that allow the user to connect to and interact with a metaverse. In an embodiment, one or more of the client computers 202a . . . n are video game consoles.

In an embodiment, the computer 101 hosts a simulated virtual world, or metaverse, accessed by each of the plurality of the client computers 202a . . . n, although the computer 101 may host the metaverse for only a single client (client computer 202a, for example). In one embodiment, the computer 101 is an array of servers. In one embodiment, a specified area of the metaverse is simulated by a single server instance, and multiple server instances may be run on a single computer 101. In some embodiments, the computer 101 includes a plurality of simulation servers dedicated to physics simulation in order to manage interactions between characters and objects in a metaverse. The computer 101 also may include a plurality of storage servers, apart from the plurality of simulation servers, dedicated to storing data related to objects and characters in the metaverse. The data stored on the plurality of storage servers may include object shapes, avatar shapes and appearances, audio clips, metaverse related scripts, and other metaverse related objects. The plurality of storage servers may also store data associated with peer-engagement contact groups.

In an embodiment, the network 204 may comprise a wide area network, such as WAN 102. In an embodiment, the network 204 may comprise a local area network (LAN). The network 204 may further communicate traditional block I/O, for example, over a storage area network (SAN). The network 204 may also communicate file I/O, for example, using a transmission control protocol/Internet protocol (TCP/IP) network or similar communication protocol.

It should be noted that, as used herein, the term “client” (and/or “host”) means a processing device or system, such as a workstation, desktop computer, mobile computer, tablet computer, gaming console or the like that resides client-side in a client/server(s) relationship with the computer 101, and that the client and server(s) communicative with one another together are referred to herein as the “virtual system”.

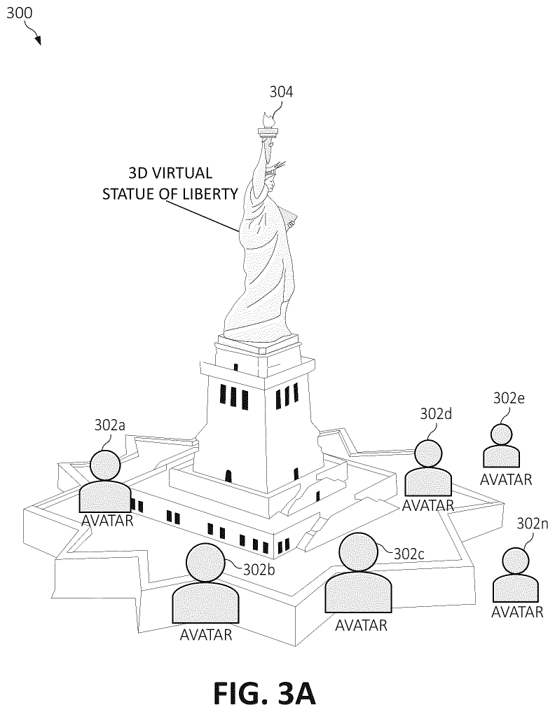

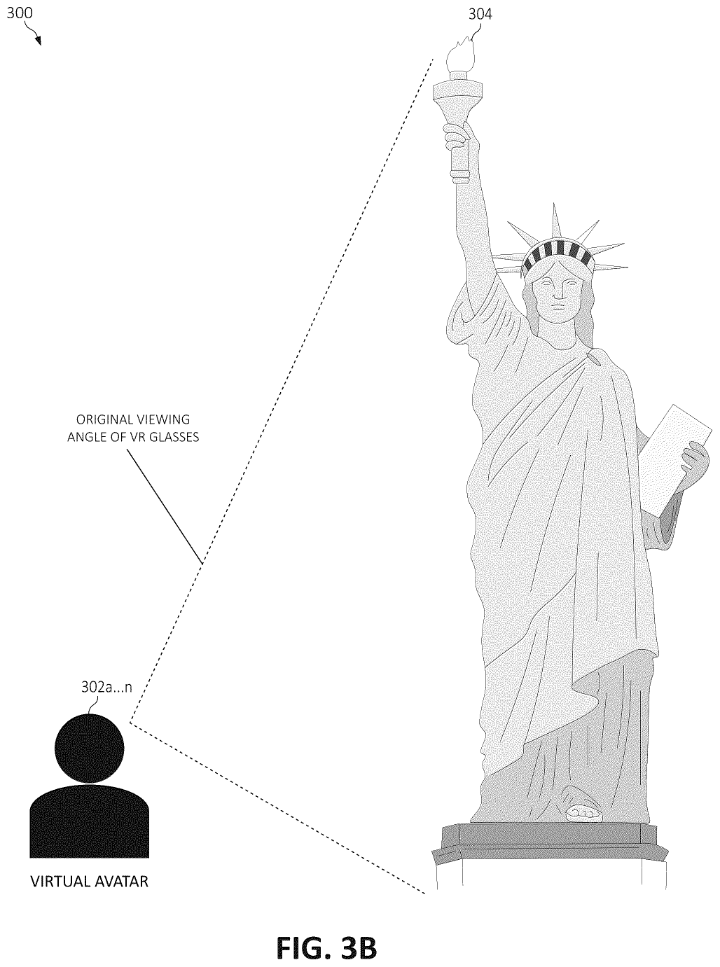

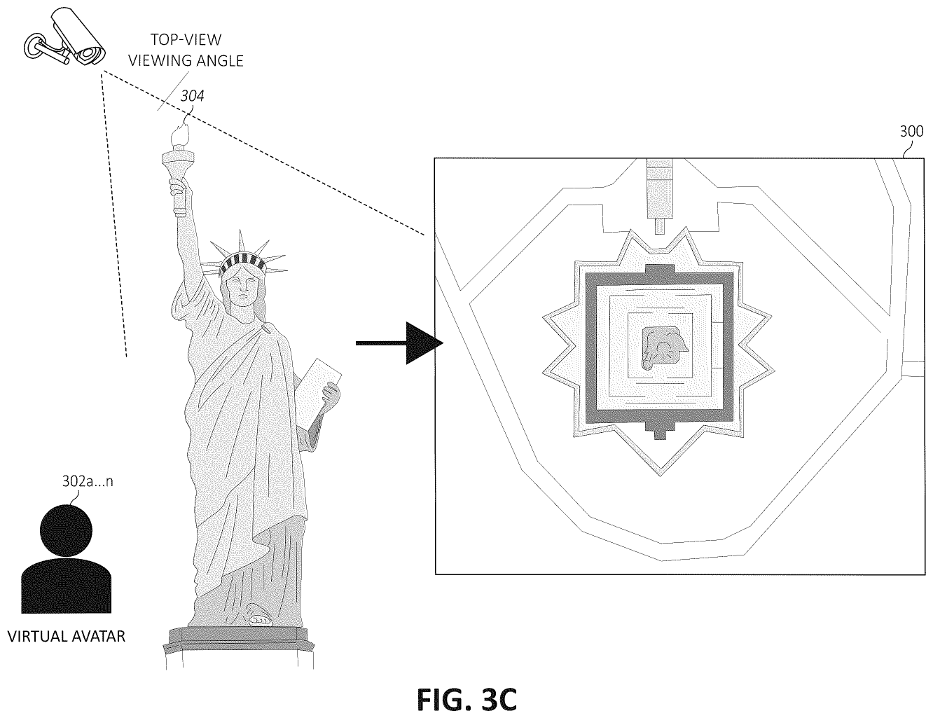

Referring now to FIG. 3A, a schematic view depicting a scene 300 in a virtualized metaverse is illustrated. As shown, the scene 300 is a virtual representation of a real-world environment having therein a three-dimensional (3D) virtualized object 304 rendered (i.e., the Statue of Liberty situated on Liberty Island in New York Harbor of New York City in the United States). The scene 300 may be generated, for example, by computer 101 acting as a metaverse server hosting the metaverse environment in which the scene 300 is rendered, with users associated with the client computers 202a . . . n accessing the metaverse environment by way of the computer 101 commensurate with the description of FIG. 2. Generally, each of the client computers 202a . . . n is associated with a single user represented in the scene 300 by a single avatar 302a, 302b, 302c, 302d, 302e, and/or 302n (collectively referred to herein as avatars 302a . . . n), although this is not a limitation (i.e., more than one user(s) may use a single client computer 202a . . . n and/or a single user may be represented by more than one of the avatars 302a . . . n).

As aforementioned, a feature of the metaverse is the ability to bring together users from all over the world into the same virtual environment. These users may be located in differing countries and associate with different cultures, yet share similar interests and hobbies based on the virtual environment they attend. Referencing scene 300 as an example, scene 300 includes the object 304 which is a known tourist attraction, depicted as a 3D Statue of Liberty. As shown in the scene 300, several users, represented by their respective avatars 302a . . . n, may be present at the object 304 at any given time, and it is assumed that because these users are viewing the same object 304, the users likely have at least one similar interest (i.e., viewing the Statue as a virtualized tourist). Accordingly, some users may desire to generate contact (i.e., exchange information, save the profile of, or otherwise obtain user data to enable communication) with another user given that the users have already at least implicitly revealed they likely share similar interests by their presence in the scene 300.

However, because of widely varying user behaviors with respect to movement in environments such as the one depicting the scene 300, it may prove difficult for one user (e.g., associated with avatar 302a) to connect (i.e., begin communication, request friendship, or otherwise associate) with another user (e.g., associated with avatar 302e), especially considering the two users may be at many or all points in time of their session respectively located on opposite sides of the scene 300.

In other words, in such a virtual environment such as the one depicted in the scene 300, some users tend to move slowly, casually observe, or otherwise maintain a relatively similar position within the environment for a period of time. Other users may tend to move swiftly and relocate frequently to many different positions within the environment over the same period of time. Therefore, it may be relatively simple for a user (e.g., associated with avatar 302a) to approach and express a desire to generate contact with another user (e.g., associated with avatar 302b) when both users are in close proximity and “run into” one another within the scene 300. Conversely, a user (e.g., associated with avatar 302a) may entirely miss generating contact with another user (e.g., associated with avatar 302d) during times when at least one of the users moves quickly throughout the scene 300, is not made aware of one another, and/or otherwise “misses” one another as each user moves throughout (or exits) the scene 300. This situation is compounded by the default viewing angle of the user experiencing the scene 300 and/or object 304 the user views during the rendering of the virtual environment. FIG. 3B depicts the generally displayed original viewing angle as seen through the glasses portion of a VR headset experienced by the user when inside the scene 300. As shown, the original viewing angle of the user (represented by one or more of the virtual avatars 302a . . . n) is one of a natural real-world style viewing angle (i.e., as a human would view the object 304 in the physical world), thereby proving difficult for the user to identify another user on an opposite side of the object 304 by their respective avatar.

Accordingly, in an embodiment, the present invention improves the ability to connect with different users in the virtual environment by enabling users to proactively and graphically define, within the virtual environment, areas or zones, actions, and/or triggers which initiate a process by which one user may attempt to connect with another user within the same virtual environment (i.e., to communicate with and/or save information relating to the another user to form a connection as a “friend”). It should be noted that the disclosure refers to each of these areas, actions, and/or triggers as “contact-generating events”, which may include any or all of the methods described, following. Further, it should be noted that these contact-generating events themselves do not automatically bind users as friends or contacts within the virtual environment, but rather enable two or more users within the environment who potentially may desire to maintain contact with one another are able to do so. In other words, the contact-generating events ensure the users are made aware of one another, after which the users may themselves view profile information of and/or communicate with one another and determine whether to remain in contact subsequent thereto.

To define these events, a user (associated with one or more of the avatars 302a . . . n) first obtains the map of the virtual environment where their avatar is located, such as a miniature 3D model of the virtual environment. In one embodiment, this includes obtaining the top-down (2D layer) view of the virtual environment as the map by changing the viewing angle of the user's VR headset to the top-down view of the scene 300. Doing so visually presents such a 2D map in the field of view of the user's VR headset, illustrated by the depiction of the scene 300 in FIG. 3C.

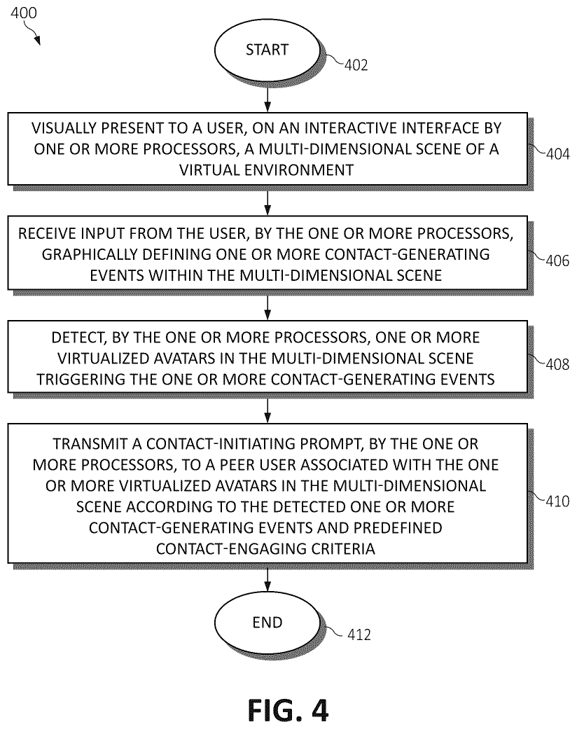

FIG. 4 provides an overview of the remaining steps as a computer-implemented method 400 for peer-engagement through graphical definition of contact-generating events in a virtualized metaverse. It should be understood that the operations of the computer-implemented method 400 may be performed by the processor set 110 of the computer 101 depicted in the computing environment 100 of FIG. 1 by executing computer code of the peer-engagement operations module 200, commensurate with the description of such in FIGS. 1 and 2.

The computer-implemented method 400 starts (step 402), with visually presenting to a user, on an interactive interface by one or more processors, a multi-dimensional scene of a virtual environment (step 404). The computer-implemented method further receives input from the user, by the one or more processors, graphically defining one or more contact-generating events within the multi-dimensional scene (step 406). The computer-implemented method further detects, by the one or more processors, one or more virtualized avatars in the multi-dimensional scene triggering the one or more contact-generating events (step 408). The computer-implemented method further transmits a contact-initiating prompt, by the one or more processors, to a peer user associated with the one or more virtualized avatars in the multi-dimensional scene according to the detected one or more contact-generating events and predefined contact-engaging criteria (step 410). The computer-implemented method 400 ends at step 412.

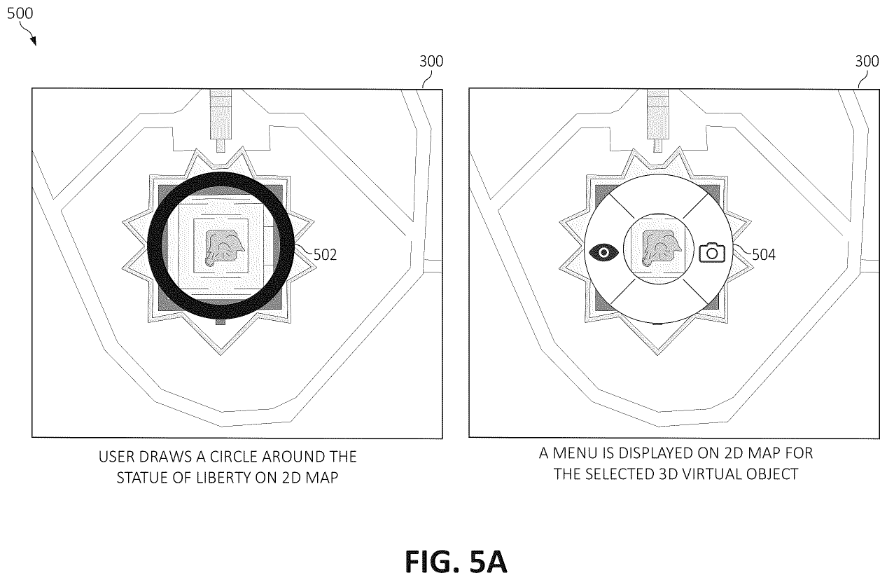

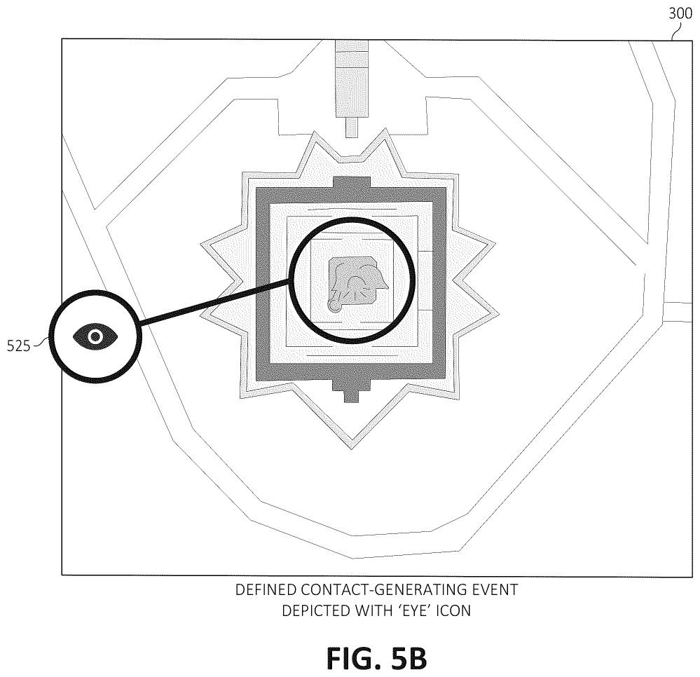

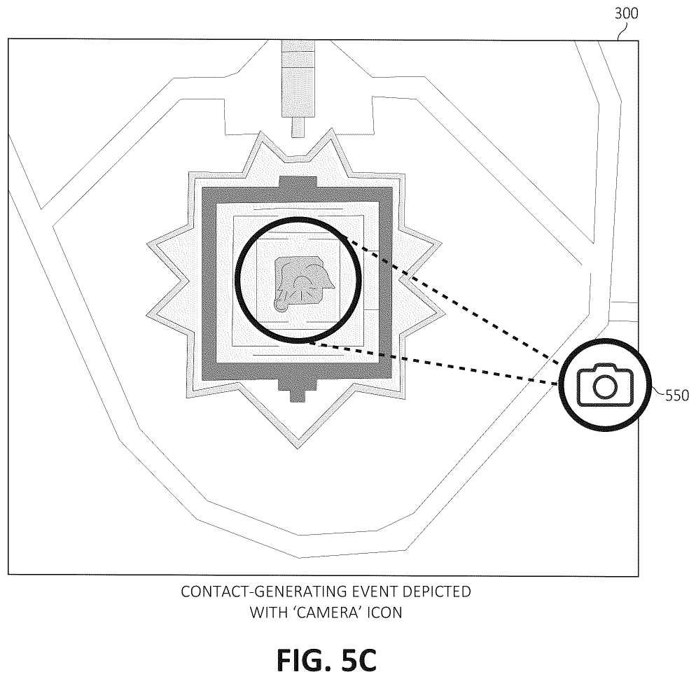

Detailing the functionality of FIG. 4, FIG. 5A is a schematic view of the scene 300 depicting mapping operations 500 to graphically define the contact-generating events in the virtualized metaverse. In operation, and subsequent to obtaining the map of the virtual environment by altering the view-point of the user (i.e., by way of switching to the top-down view of the scene 300 on the user's VR headset) the user may select a single virtual object (e.g., object 304) on the 2D map currently displayed through the glasses portion of the VR headset through an interactive operation (e.g., using a physical gesture and/or a handheld controller).

Operations 500 illustrate an example action 502 of the user “drawing” (i.e., using the same or another physical gesture and/or the handheld controller to graphically define) a circle 502 around the object 304 within the scene 300 of the virtual environment. According to the position (i.e., the XY coordinates on a rendered map/graph) selected by the user on the 2D map, the virtual system may automatically identify the selected object 304 and identify a category to which the selected object 304 belongs (this may be performed locally at the respective client device (client computers) 202a . . . n and/or by the computer 101 executing the metaverse).

For example, using the depicted object 304, the virtual system may identify that the user has drawn (or otherwise input by input means) a circle around the Statue of Liberty by virtue of the XY coordinates of the circle corresponding to the XY coordinates of the Statue, and automatically categorize the input of the user as belonging to and/or being associated with a ‘historical-and-cultural-attraction’ category based on pre-obtained environmental data. In an embodiment, according to the identified category of the selected object 304, the virtual system may, in response to the user selection of the object 304, display a corresponding menu 504 at a location where the object 304 is located on the 2D map. This menu contains menu options that correspond to the identified category. For example, the menu 504 associated with the ‘historical-and-cultural-attraction’ category may contain an option associated with user/avatar observing behavior (depicted as the ‘eye’ button in the menu 504) and/or an option associated with user/avatar photographing behavior (depicted as the ‘camera’ button in the menu 504).

In an embodiment, when the user selects the eye button from the menu 504, an eye icon 525 will be displayed on the 2D map (perhaps with a straight line connecting the newly displayed eye icon and the selected object 304), as illustrated in FIG. 5B. This graphical representation of the eye icon 525 is considered a contact-generating event indicating to the virtual system that the user (associated with one or more of the avatars 302a . . . n) desires other users (associated with others of the avatars 302a . . . n) whom have viewed the selected object 304 to be treated as potential contacts (other users whom likely have similar interests in viewing historical and cultural attractions).

Referring now to FIG. 5C, when the user selects the camera button from the menu 504, a camera icon 550 will be displayed on the 2D map. The lens of the camera on the camera icon 550 may, for example, face the selected object 304 such that the camera's field of view (represented by the dashed lines in FIG. 5C) are also displayed visually on the 2D map. As illustrated, the camera icon, the selected object 304, and the depicted camera's field of view together form another contact-generating event, indicating to the virtual system that the user (associated with one or more of the avatars 302a . . . n) desires other users (associated with others of the avatars 302a . . . n) whom have taken one or more photos (e.g., selfies) in front of the selected object 304 (i.e., the selected object 304 was present in the field of view of those avatars 302a . . . n virtual cameras when taking a photograph) to be treated as potential contacts (other users whom likely have similar interests in photographing historical and cultural attractions).

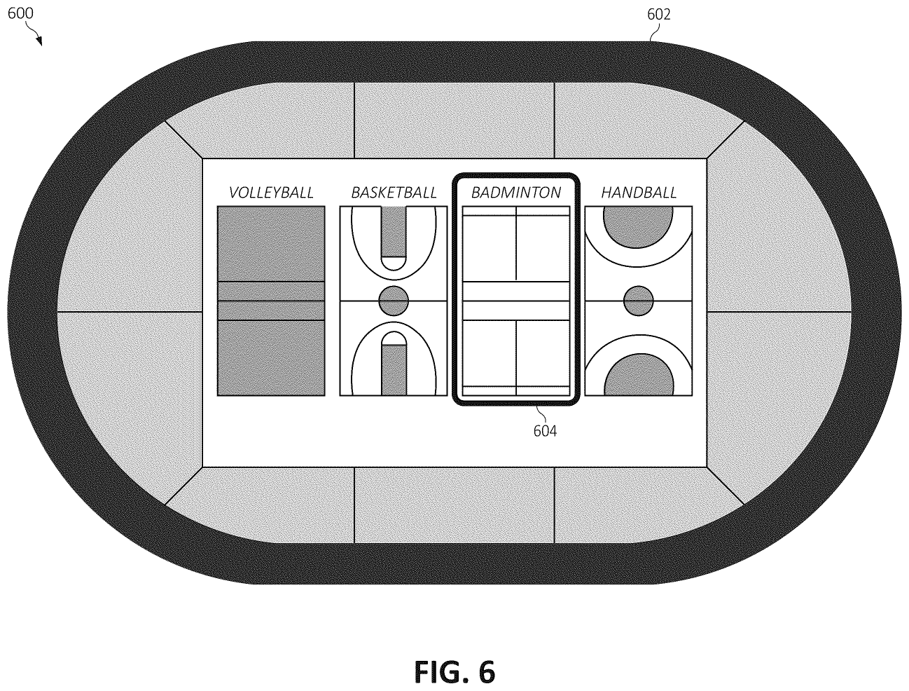

In addition to selecting a single 3D virtual object on the map of the virtual environment, the virtual system provides additional interactive operations to graphically define contact-generating events. By way of example, and without limitation, FIG. 6 depicts a top-down view of a virtual gymnasium 602 in a virtual environment 600. The virtual gymnasium 602 contains virtual courts for basketball, badminton, handball, and volleyball play. In this scenario, a user may delineate an area within the virtual gymnasium 602 to act as a contact-generating event by drawing (i.e., input by way of a physical gesture and/or utilizing a handheld controller, for example) a closed-shape line 604 on the 2D map to enclose a selected area defined as the contact-generating event. As depicted in the virtual environment 600, the user may enclose, through input, any or all of the badminton court(s), such that the delineated badminton court-area together form the contact generating event. This delineation indicates to the virtual system that the user desires other users (as associated with their respective avatar 302a . . . n) whom have entered or have been within this enclosed area (i.e., avatars who have virtually played badminton), perhaps within a predefined time period, to be treated as potential contacts to the user.

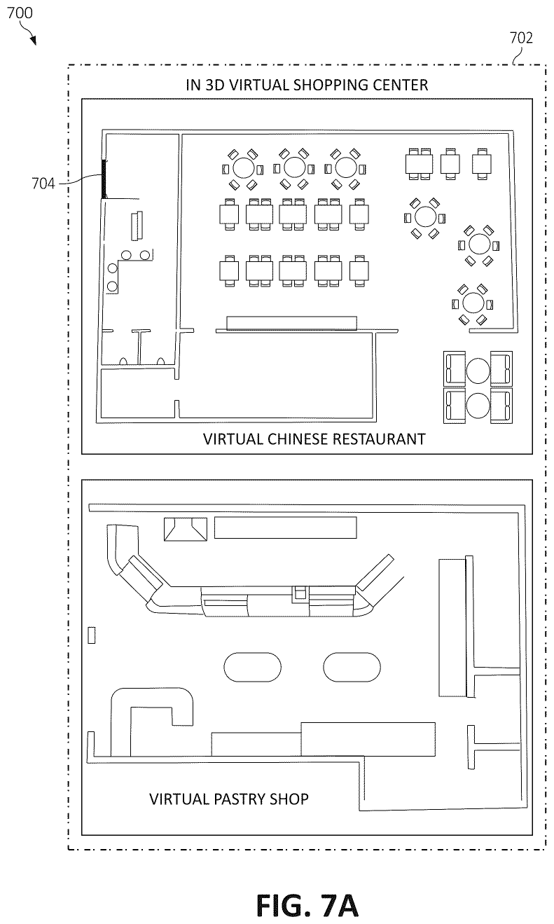

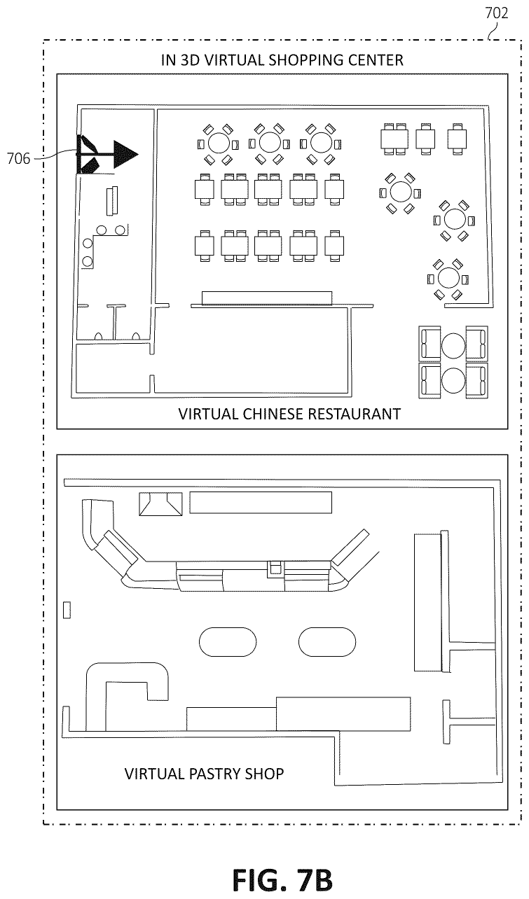

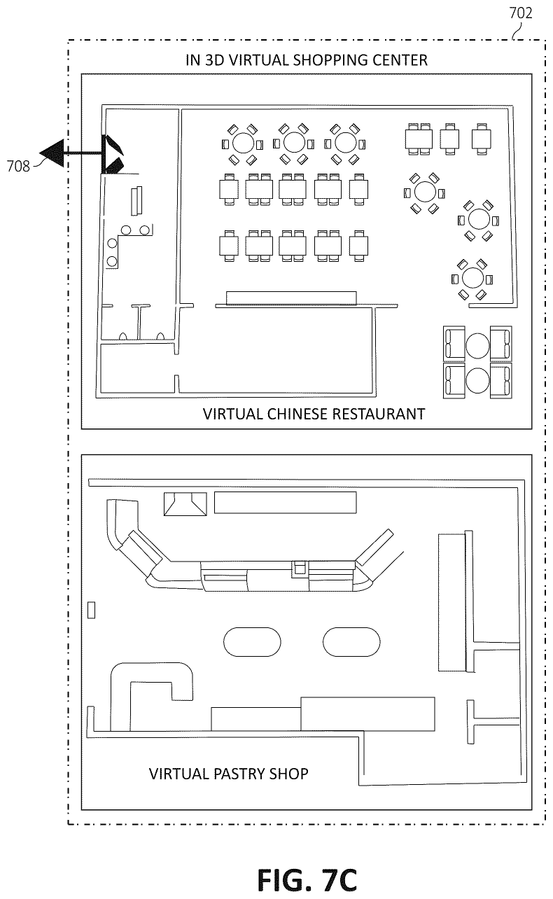

In another example, and now referring to the virtual environment 700 of FIG. 7A, a contact-generating event may be graphically defined as being triggered by a threshold indicative of user entrance and/or exit of an area. For instance, the virtual environment 700 may include a virtual shopping center 702 containing one or more virtual stores. The virtual shopping center 702, in this example, includes a Chinese restaurant and a pastry shop. To graphically define a contact-generating event with regard to an entrance/exit of, for example, the Chinese restaurant in the virtual environment 700, a user may draw (input) a straight line 704 parallel to the door of the restaurant on the 2D map by interactive means. This straight line 704 and the door of the Chinese restaurant together form a contact-generating event, indicating to the virtual system that the user desires other users (as associated with their respective avatar 302a . . . n) whom have entered, left, and/or have been within the restaurant (i.e., avatars who have ordered Chinese food online in that virtual restaurant), perhaps within a predefined time period, to be treated as potential contacts to the user.

In a scenario where the user only desires to contact avatars having entered an area, such as the Chinese restaurant, the user may graphically define the contact-generating event utilizing an ‘in’ arrow 706 pointing from the door into the restaurant, as illustrated in FIG. 7B. In another scenario where the user only desires to contact avatars having exited an area, such as the Chinese restaurant, the user may graphically define the contact-generating event utilizing an ‘out’ arrow 708 pointing from the door and out of the restaurant, as illustrated in FIG. 7C.

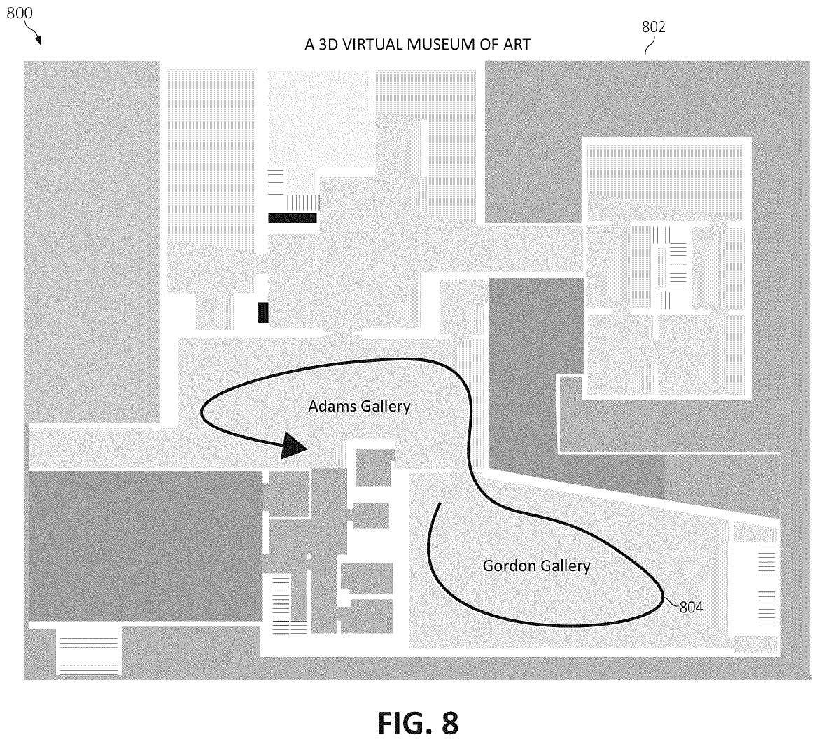

Still further, FIG. 8 illustrates the graphical definition of a contact-generating event utilizing an outlined path in a virtual museum of art 802 of a virtual environment 800. In this example, the virtual museum of art 802 contains a “Gordon Gallery” and an “Adams Gallery”. Here, a user may draw (input) a lined path 804 that begins at the Gordon Gallery to the Adams Gallery in turn on the 2D map. This lined path 804 and the two visited virtual galleries together form a contact-generating event, indicating to the virtual system that the user desires other users (as associated with their respective avatar 302a . . . n) whom have visited these galleries within the virtual museum of art 802 and/or followed on a similar path to the lined path 804 to be treated as potential contacts to the user (users whom appreciate particularly the exhibits of the Gordon and Adams galleries of the virtual museum).

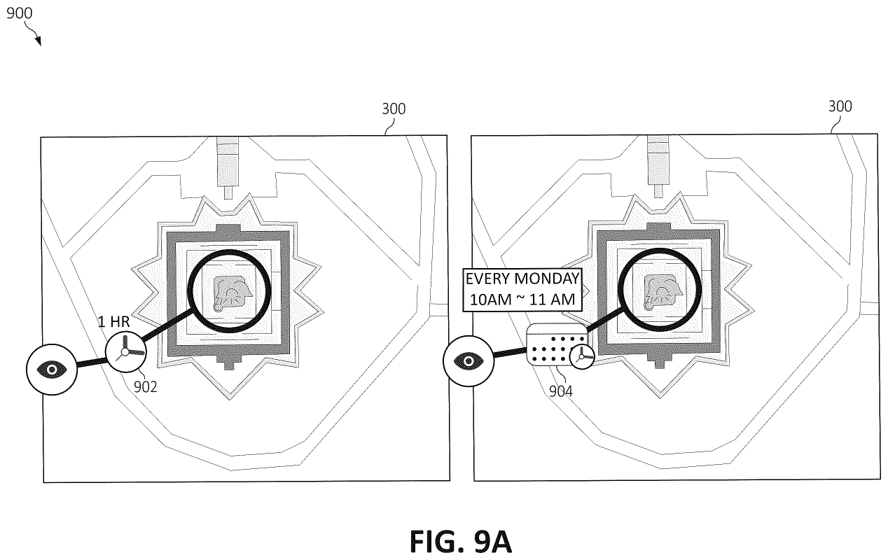

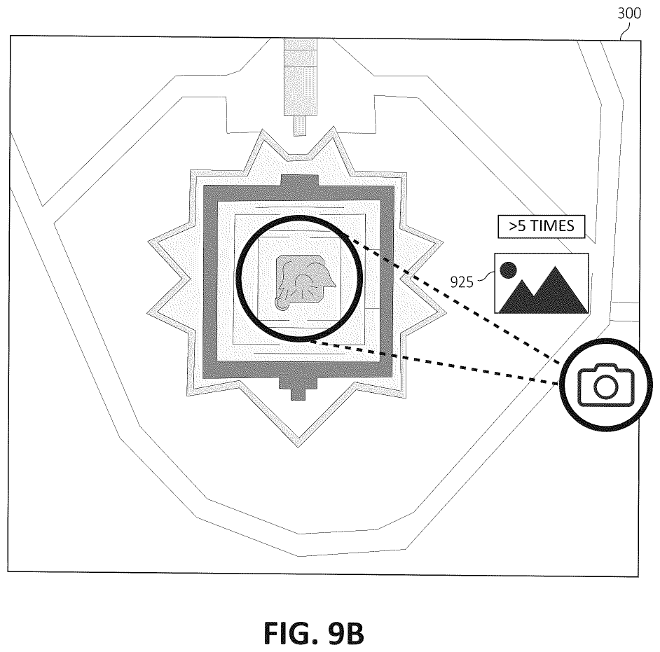

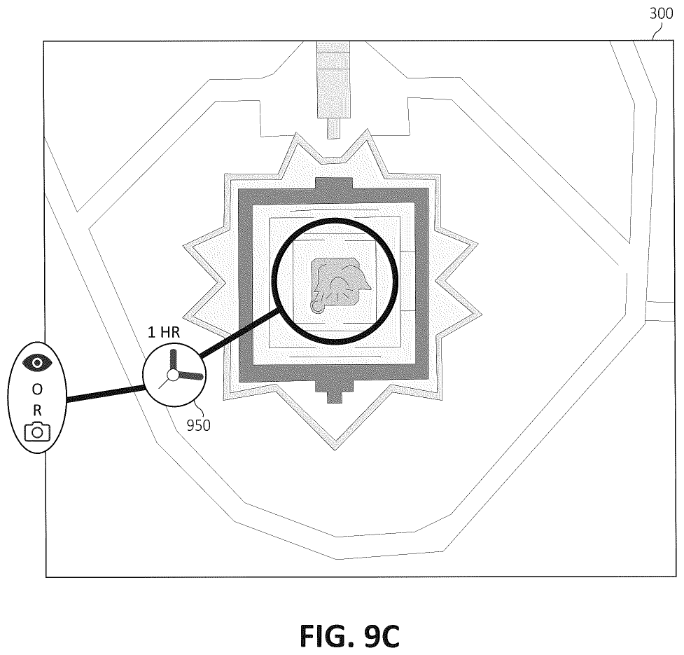

In embodiment, in addition to graphically defining the respective contact-generating events, the virtual system may enable the user to further filter the other users (and their respective avatars 302a . . . n) whom trigger the event(s) by various criteria. Referring to the virtual environment 900 of FIG. 9A, for example, a user implementing the eye icon 525 may further filter other users, whom otherwise meet the criteria as being a potential contact by viewing the object 304 of FIG. 5A, by a time constraint 902 or 904 indicative of a specific time slot or time interval when the other user's avatar 302a . . . n viewed the object 304. Similarly, as illustrated in FIG. 9B, user's utilizing the camera icon 550 may further filter other users whose avatars 302a . . . n took photographs of the object 304 by a photo constraint 925 indicative of a number of times a photo was taken, a duration of time of photo taking, and/or a specific time slot or time interval during which the photo taking occurred.

In another example, when a user inputs the closed-shape line 604 enclosing an area on the 2D map, further filtering options for the contact-generating event(s) may include time slots or a time interval when the respective avatars 302a . . . n entered and/or exited the area, a duration of time of a stay in the area, a frequency of occurrence of the respective avatars 302a . . . n in the area, and the like.

In another example, the straight line 704 defining a contact-generating event as a respective avatar 302a . . . n entering or exiting a defined shop or location, further filtering options may include time slots and/or a time interval when people entered and/or exited the door, a duration of time of stay, and/or a frequency of entrance/exit. Similarly, further filtering options for the contact-generating event defined by the drawn path 804 may include a time period during which movement was made and/or a number of times a respective avatar 302a . . . n has been observed moving along the drawn path 804. Other general filters may additionally exist, including, without limitation, profile-related information of respective avatars 302a . . . n (e.g., a virtual age, gender, etc.)

It should be noted that, in some embodiments, users may be enabled to logically combine multiple contact-generating events by, for example, utilizing AND and OR operators. FIG. 9C illustrates an example contact-generating event having a combined constraint 950 in which the user desires other avatars 302a . . . n whom have viewed OR taken photos with the selected object 304 for a predetermined time period (e.g., an hour) to be treated as potential contacts within the virtual system.

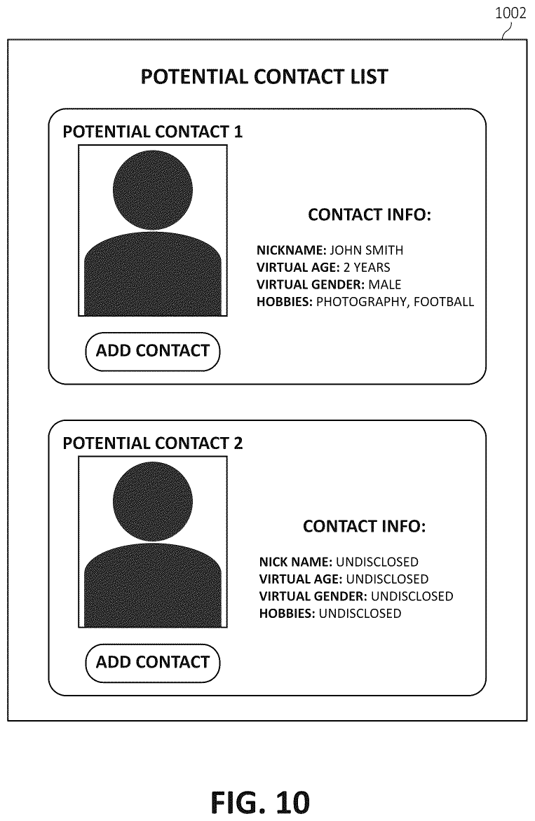

Subsequent to the contact-generating event(s) being defined, the virtual system is able to detect the line of sight and moving position of the avatars 302a . . . n within a virtual environment in real-time. As the virtual system monitors these movements, if any of the avatars 302a . . . n meet the defined criteria of any of the contact-generating event(s) (inclusive of any applicable additional filtering criteria), those avatars meeting all defined criteria are displayed/recommended in a viewing window of the user's VR headset. FIG. 10 illustrates an exemplary potential contact list 1002 of those avatars satisfying the contact-generating criteria. This potential contact list 1002 includes a list of the potential contact(s), displayed in various granularity, according to public information of each of the recommended potential contact(s), disclosed by the potential contact(s) to the virtual system themselves. The user may browse the potential contact list 1002 and select an “add contact” button (or otherwise use input to initiate communication between the user and the potential contact) as the user desires. Once selected, the user (operating as one of the client computers 202a . . . n) transmits the contact request to the virtual system, which prompts one of the other users (the potential contact) to connect with the user as mutual contacts. Based on a response to this prompt, the potential contact may input a selection to become mutual contacts, which is then reflected in each of the user's virtual contact/friends list, initiate communication with the user, or deny the request.

It should be noted that, in some embodiments, the methods and/or systems described herein may utilize a “cognitive analysis,” “cognitive system,” “machine learning,” “cognitive modeling,” “predictive analytics,” and/or “data analytics,” as is commonly understood by one skilled in the art.

Generally, these processes may include, for example, executing machine learning logic or program code to receive and/or retrieve multiple sets of inputs, and the associated outputs, of one or more systems and processing the data (e.g., using a computing system and/or processor) to generate or extract models, rules, etc. that correspond to, govern, and/or estimate the operation of the system(s), or with respect to the embodiments described herein, the generation of user experience models, as described herein. Utilizing the models, the performance (or operation) of the system (e.g., utilizing/based on new inputs) may be predicted and/or the performance of the system may be optimized by investigating how changes in the input(s) effect the output(s). Feedback received from (or provided by) users and/or developers may also be utilized, which may allow for the performance of the system to further improve with continued use.

In certain embodiments, the cognitive analyses described herein may apply one or more heuristics and machine learning based models using a wide variety of combinations of methods, such as supervised learning, unsupervised learning, temporal difference learning, reinforcement learning and so forth. Some non-limiting examples of supervised learning which may be used with the present technology include averaged one-dependence estimators (AODE), artificial neural network, backpropagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, distributed autonomous entity systems based interaction (IBSEAD), association rule learning, apriori algorithm, Equivalence Class Clustering and bottom-up Lattice Traversal (ECLAT) algorithm, Frequent Pattern (FP)-growth algorithm, hierarchical clustering, single-linkage clustering, conceptual clustering, partitional clustering, k-means algorithm, fuzzy clustering, and reinforcement learning. Some non-limiting examples of temporal difference learning may include Quality (Q)-learning and learning automata. Specific details regarding any of the examples of supervised, unsupervised, temporal difference or other machine learning described in this paragraph are known and are considered to be within the scope of this disclosure.

For example, machine learning and/or artificial intelligence (AI) may be utilized to identify behavior of the user and/or the other users associated with the avatars 302a . . . n. In some implementations, the virtual system may, over time, learn types of contact-generating events preferred and not-preferred by the user and/or any constraints or filtering options generally utilized by the user. This may include identifying which types of categories the user generally establishes contact-generating events for, at which virtual locations, and/or at which times. The system then may provide recommendations to the user with respect to subsequent contact-generating events, potential contacts, and/or additional peer-engagement operations which may be helpful to or desired by the user.

It should be noted that, as used herein, the terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary, a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer-implemented method for peer-engagement through graphical definition of contact-generating events in a virtualized metaverse, the computer-implemented method comprising:
visually presenting to a user, on an interactive interface by one or more processors, a multi-dimensional scene of a virtual environment;
receiving input from the user, by the one or more processors, graphically defining one or more contact-generating events within the multi-dimensional scene;
detecting, by the one or more processors, one or more virtualized avatars in the multi-dimensional scene triggering the one or more contact-generating events; and
transmitting a contact-initiating prompt, by the one or more processors, to a peer user associated with the one or more virtualized avatars in the multi-dimensional scene according to the detected one or more contact-generating events and predefined contact-engaging criteria.

2. The computer-implemented method of claim 1, wherein the multi-dimensional scene comprises:
a two-dimensional (2D) map of the virtual environment comprising one or more virtualized objects; or
a miniaturized three-dimensional (3D) model of the virtual environment comprising the one or more virtualized objects.

3. The computer-implemented method of claim 2, wherein:
a graphically defining of the one or more contact-generating events comprises receiving the input from the user to select an object of the one or more virtualized objects as a location boundary of the one or more contact-generating events; and
a triggering of the one or more contact-generating events comprises identifying the peer user associated with the one or more virtualized avatars has viewed the object.

4. The computer-implemented method of claim 2, wherein:
a graphically defining of the one or more contact-generating events comprises receiving the input from the user to draw one of a plurality of symbols respectively representative of a plurality of predefined actions requisite to initiate the one or more contact-generating events; and
a triggering of the one or more contact-generating events comprises identifying the peer user associated with the one or more virtualized avatars has performed one or more of the plurality of predefined actions.

5. The computer-implemented method of claim 2, wherein the one or more virtualized objects are real-world objects represented in the virtual environment; and
further comprising automatically identifying a category of the one or more virtualized objects in the virtual environment by known information of the real-world objects, wherein the category consists of a portion of the predefined contact-engaging criteria.

6. The computer-implemented method of claim 1, further comprising:
filtering, by the one or more processors, the one or more virtualized avatars detected as having triggered the one or more contact-generating events according to the predefined contact-engaging criteria; and
visually presenting to the user, by the one or more processors on the interactive interface, a list of filtered one or more virtualized avatars.

7. The computer-implemented method of claim 1, further comprising, responsive to accepting the contact-initiating prompt by the peer user associated with the one or more virtualized avatars, connecting the user and the peer user as contacts in the virtualized metaverse.

8. A system for peer-engagement through graphical definition of contact-generating events in a virtualized metaverse, comprising:
one or more processors; and
one or more memory storing instructions executed by the one or more processors, the instructions, when executed, causing the one or more processors to:
visually present to a user, on an interactive interface, a multi-dimensional; scene of a virtual environment;
receive input from the user graphically defining one or more contact-generating events within the multi-dimensional scene;
detect one or more virtualized avatars in the multi-dimensional scene triggering the one or more contact-generating events; and
transmit a contact-initiating prompt to a peer user associated with the one or more virtualized avatars in the multi-dimensional scene according to the detected one or more contact-generating events and predefined contact-engaging criteria.

9. The system of claim 8, wherein the multi-dimensional scene comprises:
a two-dimensional (2D) map of the virtual environment comprising one or more virtualized objects; or
a miniaturized three-dimensional (3D) model of the virtual environment comprising the one or more virtualized objects.

10. The system of claim 9, wherein:
a graphically defining of the one or more contact-generating events comprises receiving the input from the user to select an object of the one or more virtualized objects as a location boundary of the one or more contact-generating events; and
a triggering of the one or more contact-generating events comprises identifying the peer user associated with the one or more virtualized avatars has viewed the object.

11. The system of claim 9, wherein:
a graphically defining of the one or more contact-generating events comprises receiving the input from the user to draw one of a plurality of symbols respectively representative of a plurality of predefined actions requisite to initiate the one or more contact-generating events; and
a triggering of the one or more contact-generating events comprises identifying the peer user associated with the one or more virtualized avatars has performed one or more of the plurality of predefined actions.

12. The system of claim 9, wherein the one or more virtualized objects are real-world objects represented in the virtual environment; and
wherein, when executed, the instructions further cause the one or more processors to automatically identify a category of the one or more virtualized objects in the virtual environment by known information of the real-world objects, wherein the category consists of a portion of the predefined contact-engaging criteria.

13. The system of claim 8, wherein, when executed, the executable instructions further cause the one or more processors to:
filter the one or more virtualized avatars detected as having triggered the one or more contact-generating events according to the predefined contact-engaging criteria; and
visually present to the user, on the interactive interface, a list of the filtered one or more virtualized avatars.

14. The system of claim 8, wherein, when executed, the executable instructions further cause the one or more processors to, responsive to accepting the contact-initiating prompt by the peer user associated with the one or more virtualized avatars, connect the user and the peer user as contacts in the virtualized metaverse.

15. A computer program product for peer-engagement through graphical definition of contact-generating events in a virtualized metaverse, the computer program product comprising:
one or more computer readable storage media, and program instructions collectively stored on the one or more computer readable storage media, the program instructions comprising:
program instructions to visually present to a user, on an interactive interface by; one or more processors, a multi-dimensional scene of a virtual environment;
program instructions to receive input from the user, by the one or more processors, graphically defining one or more contact-generating events within the multi-dimensional scene;
program instructions to detect, by the one or more processors, one or more virtualized avatars in the multi-dimensional scene triggering the one or more contact-generating events; and
program instructions to cause a contact-initiating prompt to be transmitted, by the one or more processors, to a peer user associated with the one or more virtualized avatars in the multi-dimensional scene according to the detected one or more contact-generating events and predefined contact-engaging criteria.

16. The computer program product of claim 15, wherein the multi-dimensional scene comprises:
a two-dimensional (2D) map of the virtual environment comprising one or more virtualized objects; or
a miniaturized three-dimensional (3D) model of the virtual environment comprising the one or more virtualized objects.

17. The computer program product of claim 16, wherein:
a graphically defining of the one or more contact-generating events comprises receiving the input from the user to select an object of the one or more virtualized objects as a location boundary of the one or more contact-generating events; and
a triggering of the one or more contact-generating events comprises identifying the peer user associated with the one or more virtualized avatars has viewed the object.

18. The computer program product of claim 16, wherein:
a graphically defining of the one or more contact-generating events comprises receiving the input from the user to draw one of a plurality of symbols respectively representative of a plurality of predefined actions requisite to initiate the one or more contact-generating events; and
a triggering of the one or more contact-generating events comprises identifying the peer user associated with the one or more virtualized avatars has performed one or more of the plurality of predefined actions.

19. The computer program product of claim 16, wherein the one or more virtualized objects are real-world objects represented in the virtual environment; and
further including program instructions to automatically identify a category of the one or more virtualized objects in the virtual environment by known information of the real-world objects, wherein the category consists of a portion of the predefined contact-engaging criteria.

20. The computer program product of claim 15, further including program instructions to:
filter the one or more virtualized avatars detected as having triggered the one or more contact-generating events according to the predefined contact-engaging criteria;
visually present to the user, on the interactive interface, a list of the filtered one or more virtualized avatars; and
responsive to accepting the contact-initiating prompt by the peer user associated with the one or more virtualized avatars, connect the user and the peer user as contacts in the virtualized metaverse.
